(19) United States
(12) Patent Application Publication
(10) Pub. No.: US 2026/0023513 A1
(43) Pub. Date: Jan. 22, 2026

(54) INFORMATION PROCESSING APPARATUS, CONTROL METHOD OF INFORMATION PROCESSING APPARATUS, AND STORAGE MEDIUM

(71) Applicant: CANON KABUSHIKI KAISHA, Tokyo (JP)

(72) Inventor: SHINYA ENDO, Kanagawa (JP)

(21) Appl. No.: 19/266,303

(22) Filed: Jul. 11, 2025

(30) Foreign Application Priority Data
Jul. 18, 2024 (JP) 2024-114964

(51) Int. Cl. G06F 3/12

(52) U.S. Cl. CPC G06F 3/1229; G06F 3/1204; G06F 3/1288

(57) ABSTRACT

An information processing apparatus obtains information indicating the number of sheets on which the image forming apparatus performed image formation in a predetermined period and a use amount of a printing material required for the image formation, derives a use amount of the printing material per a predetermined number of sheets based on the obtained information, and causes a terminal used by the user to output a UI screen generated based on the derived use amount of the printing material per the predetermined number of sheets and an upper limit of the use amount of the printing material per the predetermined number of sheets in a contract in the subscription service. The UI screen displays the number of sheets on which image formation can be performed and the use amount of the printing material per the predetermined number of sheets.

### BACKGROUND

### Field of the Technology

The present disclosure relates to an information processing apparatus, a control method of an information processing apparatus, and a storage medium.

### Description of the Related Art

In recent years, as a utilization form of an image forming apparatus such as a printer or a multi functional printer, there has been a subscription contract in which a user pays a predetermined flat fee to be capable of utilizing an image forming apparatus which forms an image and a printing material used for the formation of the image in a predetermined period. In some subscription contracts, together with a threshold for coverage rates which is an upper limit of the use amount of the printing material per sheet having a predetermined size, an additional fee in the case where an excess of the threshold for coverage rates cannot be resolved within a constant period is set. It is difficult for a user who has exceeded the threshold for coverage rates to know how many images with what degree of a coverage rate should be made to cause the coverage rate to fall below the threshold for coverage rates in a remaining period in the predetermined period, and the user demands information corresponding to the coverage rate. In this regard, Japanese Patent Laid-Open No. 2023-104559 discloses a technique of providing information corresponding to a coverage rate.

### SUMMARY

The information processing apparatus according to an embodiment of the present disclosure is an information processing apparatus for providing a subscription service of an image forming apparatus to a user, and the information processing apparatus includes: at least one memory that stores instructions; and at least one processor that executes the instructions to: obtain information indicating the number of sheets on which the image forming apparatus performed image formation in a predetermined period and a use amount of a printing material required for the image formation, derive a use amount of the printing material per a predetermined number of sheets based on the obtained information, and cause a terminal used by the user to output a UI screen generated based on the derived use amount of the printing material per the predetermined number of sheets and an upper limit of the use amount of the printing material per the predetermined number of sheets in a contract in the subscription service, wherein the UI screen displays the number of sheets on which image formation can be performed and the use amount of the printing material per the predetermined number of sheets for suppressing the use amount within the upper limit of the use amount of the printing material per the predetermined number of sheets in the contract.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram showing an example of a configuration of a printing service system;

FIG. 2 is a block diagram showing an example of a hardware configuration of an image forming apparatus;

FIG. 3 is a block diagram showing an example of a hardware configuration of a terminal apparatus;

FIG. 4 is a block diagram showing an example of a hardware configuration of a server apparatus;

FIG. 5 is a diagram showing a sequence showing communications among the apparatuses;

FIG. 6 is a flowchart showing a flow of update processing of a printing history table and a coverage rate management table;

FIG. 7 is a diagram showing an example of a coverage rate management screen;

FIG. 8 is a flowchart showing a flow of display processing of the coverage rate information screens;

FIG. 9 is a flowchart showing a flow of generation processing of the coverage rate information screens;

FIGS. 10A and 10B are diagrams showing examples of the coverage rate information screens;

FIG. 11 is a diagram showing the relationship of FIG. 11A and FIG. 11B;

FIG. 11A and FIG. 11B are flowcharts showing a flow of generation processing of the coverage rate information screens;

FIGS. 12A and 12B are diagrams showing examples of the coverage rate information screens;

FIG. 13 is a flowchart showing a flow of generation processing of the coverage rate information screens; and

FIG. 14 is a diagram showing an example of a screen for a user who has exceeded a threshold for coverage rates.

### DESCRIPTION OF THE EMBODIMENTS

Hereinafter, modes for carrying out the technique of the present disclosure will be described in detail with reference to the drawings. Note that the following present embodiments are not intended to limit the technique of the present disclosure according to claims. All combinations of features described in the embodiments are not necessarily essential as the solution of problem of the technique of the present disclosure, and a plurality of features may be combined as desired. The same configurations will be described with the same signs attached thereto. In addition, each step in flowcharts will be described with “S” attached in front.

### First Embodiment

### <Configuration of Printing Service System>

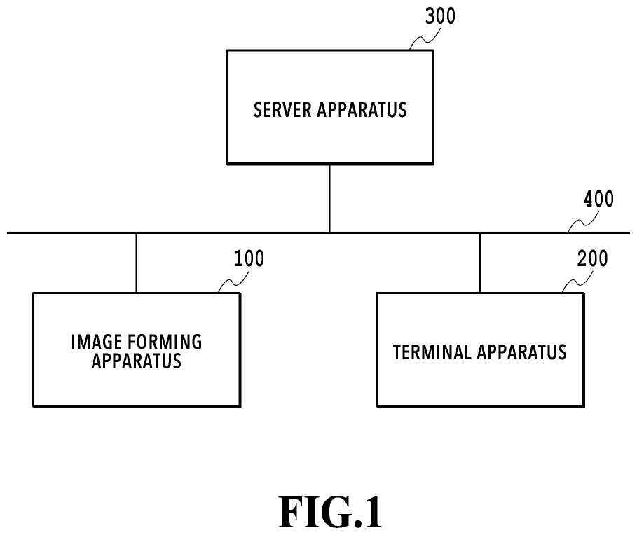

FIG. 1 is a diagram showing an example of a configuration of a printing service system according to the present embodiment. The printing service system of the present embodiment includes an image forming apparatus 100, a terminal apparatus 200, and a server apparatus 300.

The image forming apparatus 100, the terminal apparatus 200, and the server apparatus 300 are connected to a network 400 such that they can transmit and receive data to and from one another. The network 400 is a communication network achieved by Local Area Network (hereinafter, abbreviated to as LAN) or Wide Area Network (hereinafter, abbreviated to as WAN) such as the Internet, for example. Alternatively, the network 400 is a communication network achieved by a telephone line, a dedicated digital line, an ATM or frame relay line, a cable television line, a data broadcasting wireless line, or the like, for example. The type of the network 400 is not limited as long as data can be transmitted and received among components through the network 400. The present embodiment will be described on the assumption that the network 400 is the Internet.

The image forming apparatus 100 is a printer which forms an image on a printing medium such as a printing sheet by ejecting a printing material such as an ink onto the printing medium. Note that the image forming apparatus 100 may be a multi functional printer (MFP) integrally having a plurality of functions such as a copy function, a FAX function, and a printing function. The image forming apparatus 100 is assumed to be an apparatus which conducts printing by using an inkjet printing system, but is not limited to this, and may be an apparatus which conducts printing by using an electrophotographic system or a heat sublimation system, for example.

The terminal apparatus 200 is any information processing apparatus such as a smartphone, a PC (Personal Computer), a tablet terminal, a cellular phone, or a PDA (Personal Digital Assistant), for example.

Note that FIG. 1 shows the case where there are one image forming apparatus 100 and one terminal apparatus 200, but the configuration is not limited to this. For example, a configuration in which there are two or more image forming apparatuses 100 and two or more terminal apparatuses 200 is possible.

The server apparatus 300 is a server in which an application 111 which provides services to users. The server apparatus 300 receives operation information such as a print log, errors, and alerts of the image forming apparatus 100 from a printer management server managing the image forming apparatus 100, which is not shown, via the network 400, and provides a printing service to the users. The printing service is, for example, a subscription service which allows the users to use an image forming apparatus which forms images and a printing material used for forming the image in a predetermined period by paying a predetermined flat fee. In a subscription service, there is a case where in addition to a threshold of a coverage rate, which is an upper limit of a use amount of a printing material per sheet having a predetermined size, an additional fee in a case where an excess of the threshold of the coverage rate cannot be resolved within a predetermined period is provided. The server apparatus 300 stores various types of information for providing the printing service to the users, including contract information of the printing service, printing history information, and the like of the users. In the present embodiment, the server apparatus 300 provides printing service registration means such as a website to the users, and receives printing service registration from the users. The user registers a service plan, contract information, and information of the image forming apparatus 100 to the server apparatus 300 via the terminal apparatus 200, and the server apparatus 300 then holds the contract information.

### <Hardware Configuration of Image Forming Apparatus>

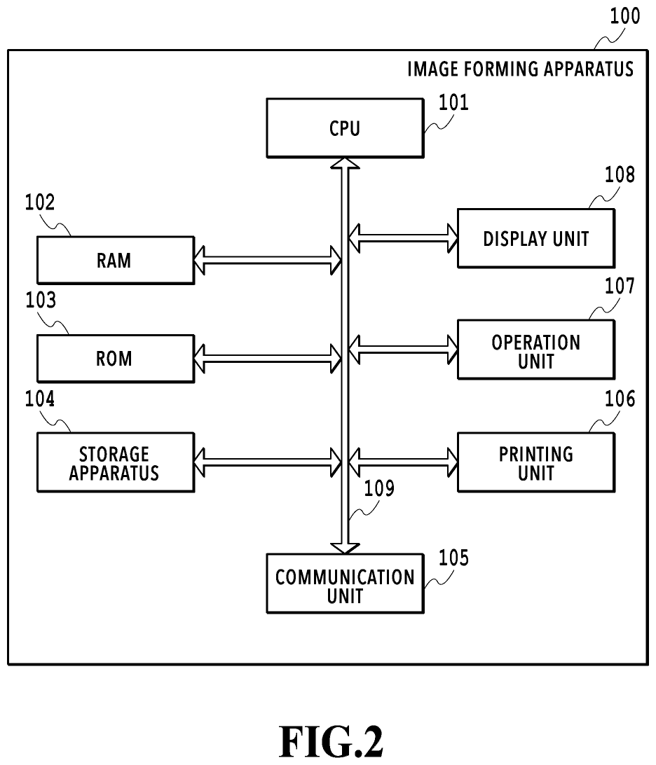

FIG. 2 is a block diagram showing an example of a hardware configuration of the image forming apparatus 100. The image forming apparatus 100 includes a CPU 101, a RAM 102, a ROM 103, a storage apparatus 104, a communication unit 105, a printing unit 106, an operation unit 107, and a display unit 108. The components included in the image forming apparatus 100 are connected to be capable of transmitting and receiving data to and from one another via a system bus 109, for example. In addition, the configuration of the image forming apparatus 100 is not limited to the configuration shown in FIG. 2, and the image forming apparatus 100 may have a configuration depending on functions which a device employed as the image forming apparatus 100 can execute.

The CPU 101 calculates, determines, and controls data and instructions in accordance with programs stored in the RAM 102 and the ROM 103. The RAM 102 is used as a temporary storage area in the case where the CPU 101 conducts various types of processing. The ROM 103 stores an operating system (OS) and the other application software. In addition, the ROM 103 may be a non-volatile memory in which data can be rewritten, represented by a flash memory.

The communication unit 105 is an interface to which a LAN cable is connected, and conducts data communications with the server apparatus 300 via a router, which is not shown, or the network 400. Note that the data communication may be conducted wirelessly by using an interface which supports wireless communications, for example.

The display unit 108 is configured with, for example, an LCD (Liquid Crystal Display) or the like, and displays various types of information. The operation unit 107 is configured with buttons, a touch panel, or the like for the user to conduct various input operations. The printing unit 106 achieves a printing function for conducting a printing operation. The printing unit 106 prints an image on a printing medium such as a printing sheet by using an inkjet system based on image data or the like received from the outside.

The processing of the communication unit 105 of the image forming apparatus 100 is achieved by the CPU 101 reading and executing programs necessary for the processing.

### <Hardware Configuration of Terminal Apparatus>

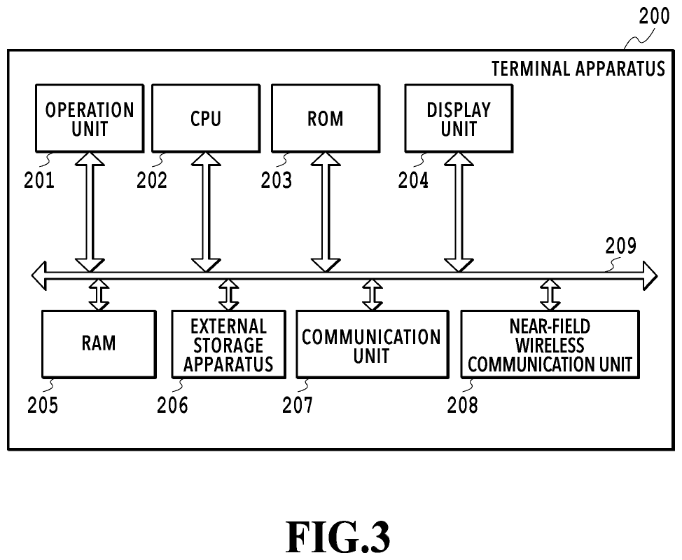

FIG. 3 is a block diagram showing an example of a hardware configuration of the terminal apparatus 200. The terminal apparatus 200 includes an operation unit 201, a CPU 202, a ROM 203, a display unit 204, a RAM 205, an external storage apparatus 206, a communication unit 207, and a near-field wireless communication unit 208. The components included in the terminal apparatus 200 are connected to be capable of transmitting and receiving data to and from one another via a system bus 209, for example. In addition, the configuration of the terminal apparatus 200 is not limited to the configuration shown in FIG. 3, and the terminal apparatus 200 may have a configuration depending on functions which a device applied as the terminal apparatus 200 can execute.

The operation unit 201 has a touch panel function which can detect touch operations of the user, and displays various screens provided by the OS or a chat application. The user can input desired operation instructions to the terminal apparatus 200 by inputting touch operations into the operation unit 201. Note that operation instructions may be inputted into the terminal apparatus 200 by using a hardware key which is not shown.

The CPU 202 is a system control unit, and is a processor which integrally controls the entire terminal apparatus 200. The RAM 205 is configured with an SRAM (Static RAM) which requires a backup power supply, for example. Note that since the RAM 205 holds data by using a primary battery for data backup, which is not shown, the RAM 205 is capable of storing data such as program control variables in a non-volatile manner. In the RAM 205, a memory area for storing setting information, management data, and the like of the terminal apparatus 200 is provided. In addition, the RAM 205 is used as a main memory and a work memory of the CPU 202. The ROM 203 stores fixed data such as a control program executed by the CPU 202, data tables, and an OS program. Note that in the terminal apparatus 200, application programs for the printing service are installed and stored in the ROM 203. The operation of the terminal apparatus 200 is achieved by the CPU 202 reading a program stored in the ROM 203 to the RAM 205 and executing the program, for example.

The display unit 204 is configured to include, for example, LEDs (light-emitting diodes) and an LCD (liquid-crystal display), and displays screens based on various display data. Note that the display unit 204 may be configured with, for example, a touch display to have a function of receiving various input operations by the user (user operations). That is, the display unit 204 may be configured as an operation panel including a physical keyboard, buttons, a touch panel, or the like, which is an interface for receiving data input and operation instructions from the user.

The external storage apparatus 206 is a large-capacity information storage apparatus represented by a hard disk drive apparatus. The external storage apparatus 206 stores computer programs, data, and the like for allowing the CPU 202 to execute or control various processing, which will be described later as being conducted by the terminal apparatus 200. The computer programs stored in the external storage apparatus 206 include a computer program for GUI, and the like.

The communication unit 207 is configured to include a circuit and an antenna for conducting communications in accordance with a predetermined wireless communication system. For example, the communication unit 207 is capable of being wirelessly connected to an external access point. In addition, there is a case where the communication unit 207 operates as a temporarily used access point. The communication unit 207 may operate in accordance with a wireless communication system of a wireless LAN compliant with the IEEE 802.11 specification series (Wi-Fi), or may operate in accordance with another wireless communication system.

The near-field wireless communication unit 208 executes near-field communications with another apparatus which is located within a certain near-field range from the terminal apparatus 200. Note that the near-field wireless communication unit 208 conducts communications in accordance with a wireless communication system different from that of the communication unit 207. For example, the near-field wireless communication unit 208 operates in accordance with the Bluetooth (registered trademark) specifications.

### <Hardware Configuration of Server Apparatus>

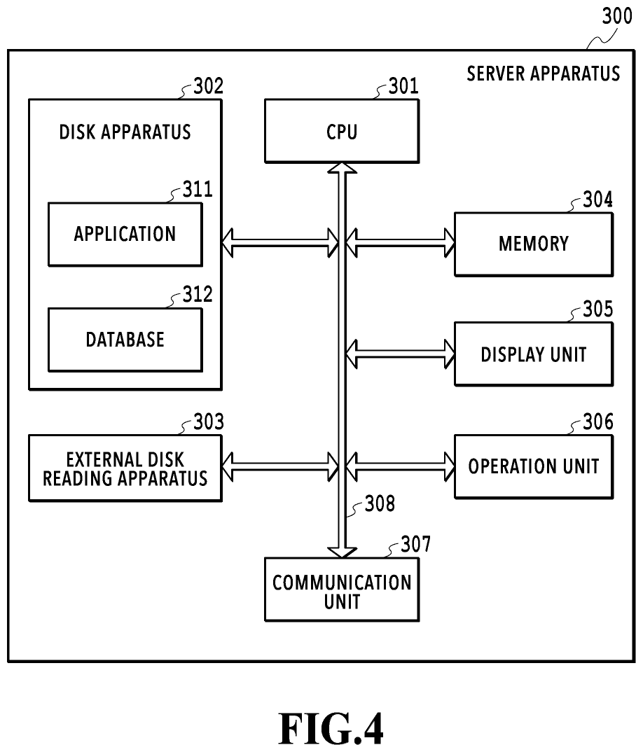

FIG. 4 is a block diagram showing an example of a hardware configuration of the server apparatus 300. The server apparatus 300 includes a CPU 301, a disk apparatus 302, an external disk reading apparatus 303, a memory 304, a display unit 305, an operation unit 306, and a communication unit 307. The disk apparatus 302 stores an application program 311 and a database 312.

The CPU 301 is a central processing unit for controlling each component described below. The disk apparatus 302 stores various files in addition to the application program 311, the database 312, and the OS which are read by the CPU 301. The external disk reading apparatus 303 is an apparatus for reading information such as files stored in an external storage medium such as an SD card. The memory 304 is configured with a RAM or the like, and the CPU 301 conducts temporal storage of data, buffering of data, and the like by using the memory 304 as necessary.

The display unit 305 is configured with, for example, an LCD, and displays various types of information. The operation unit 306 is composed of a keyboard, a mouse, and the like with which the user conducts various input operations. The communication unit 307 is connected to a network such as the Internet, and conducts various communications. The communication unit 307 supports a wired LAN or a wireless LAN. Then, the components included in the server apparatus 300 are connected to be capable of transmitting and receiving data to and from one another via a system bus 308, for example.

Note that although FIG. 1 shows the case where the server apparatus 300 is configured with one server, which is the information processing apparatus, the configuration is not limited to this. For example, the server apparatus 300 may be configured with two or more servers. That is, each function may be executed by a plurality of servers operating in cooperation.

### <Information Managed by Server Apparatus>

In the database 312 of the server apparatus 300, each data of management tables shown below is set by an administrator of the printing service. That is, the management tables include a service plan management table of Table 1, a table of display reference coverage rate management with the number of grace days of Table 2, and a table of display reference coverage rate management with the current coverage rate and the number of print sheets of Table 3, which will be described later.

The following Table 1 is an example of a service plan management table, which is managed by the database 312.

TABLE 1
Service plan management table

| | | | Number | | | | |
|---|---|---|---|---|---|---|---|
| | | Threshold | of grace | | | Number | |
| | | for coverage | days of | Billing | Contract | of | Fee |
| Plan ID | Type | rates | excess | interval | period | sheets | (yen) |
| plan A | color | 25% | 60 | 1 month | 1 year | 100 | 200 |
| plan B | monochrome | 20% | 60 | 1 month | 1 year | 100 | 200 |

The Plan ID column is IDs for uniquely identifying service plans provided by the printing services. The Type column shows whether the print type is Service plan of color or monochrome. The Threshold for coverage rates column shows an upper limit of the coverage rate, which is an upper limit of the use amount of the print material usable on printing sheets having a predetermined size in the service plan. The Number of grace days of excess column shows the number of days which is a period during which an average of coverage rates of printing conducted by the user during the contract period is allowed to continuously exceed the threshold for coverage rates. In the case where the average of coverage rates has exceeded the threshold for coverage rates over the number of grace days of excess, an additional fee may be charged to the user. The Billing interval column shows an interval at which billing is made. The Contract period column shows a contract period of the service plan. Note that the billing interval and the contract period may be different from each other. The Number of prints column shows the upper limit of the number of print sheets that can be printed within the period of the billing interval. The Fee column shows a fee of the service plan which is charged at every billing interval. For example, in the case where the plan ID in Table 1 is the service plan of plan A, the fee is charged at a fixed price of 200 yen per month.

The following Table 2 is an example of a table of a display reference coverage rate for the number of remaining grace days base, which is managed by the database 312.

TABLE 2
Table of display reference coverage rate for
the number of remaining grace days base

| | Number of remaining | Display reference |
|---|---|---|
| Plan ID | grace days (period) | coverage rate |
| plan A | 40 or more | 20% |
| plan A | less than 40 and 20 or more | 15% |
| plan A | less than 20 and 10 or more | 10% |
| plan A | less than 10 | 5% |
| plan B | 30 or more | 15% |
| plan B | less than 30 and 10 or more | 10% |
| plan B | less than 10 | 5% |

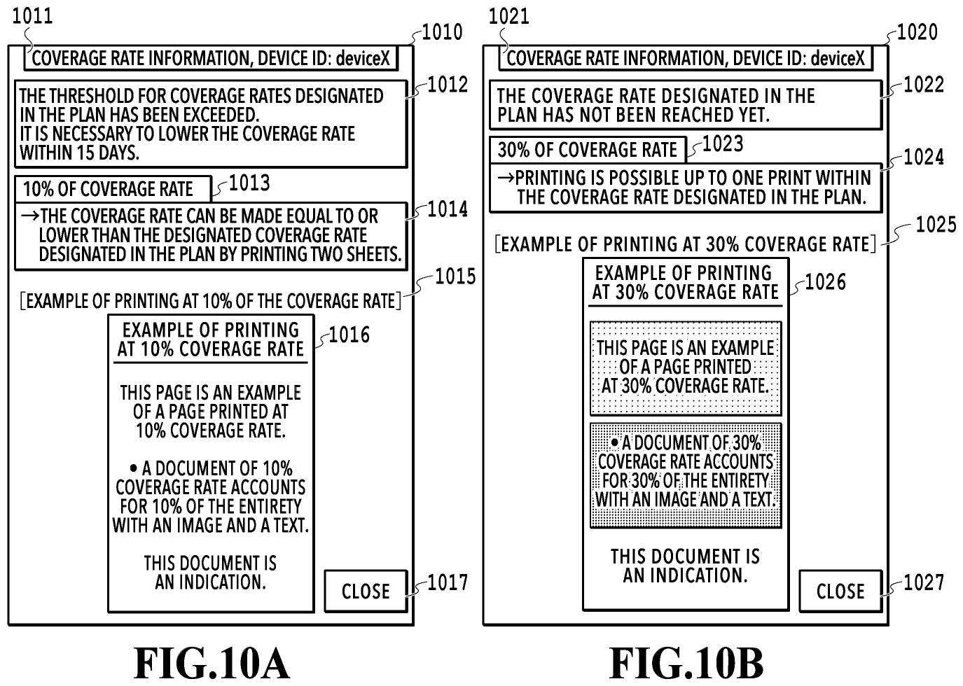

The Plan ID column is IDs for uniquely identifying service plans, and shows the service plans managed in the service plan management table of Table 1. The Number of remaining grace days (period) column shows a period of the number of remaining grace days. Note that the number of remaining grace days is the number of remaining days by which the number of elapsed days after the threshold for coverage rates is exceeded for each service plan specified in the service plan management table of Table 1 elapses the number of grace days of excess specified for each service plan. The Display reference coverage rate column shows a coverage rate used for display in FIG. 10A, which is a coverage rate information screen described later. For example, it indicates that in the case where the plan ID of Table 1 is the service plan of plan A and the number of remaining grace days is 25, the display reference coverage rate is 15%. That is, the display reference coverage rate is obtained to satisfy the threshold for coverage rates in a predetermined period, and can thus be said to be a reference coverage rate.

The following Table 3 is an example of a table of a display reference coverage rate for the current coverage rate and the total number of print sheets, which is managed by the database 312.

TABLE 3
Table of display reference coverage rate for the current
coverage rate and the total number of print sheets

| | Total number of | | Display reference |
|---|---|---|---|
| Plan ID | print sheets (range) | Current coverage rate (range) | coverage rate |
| plan A | less than 10 | 15% or more and less than 25% | 30% |
| plan A | less than 10 | 5% or more and less than 15% | 35% |
| plan A | less than 10 | less than 5% | 40% |
| plan A | 10 or more and less than 50 | 15% or more and less than 25% | 35% |
| plan A | 10 or more and less than 50 | 5% or more and less than 15% | 40% |
| plan A | 10 or more and less than 50 | less than 5% | 45% |
| plan B | 50 or more | 5% or more and less than 15% | 45% |
| plan B | 50 or more | less than 5% | 50% |
| plan B | less than 25 | 5% or more and less than 15% | 30% |
| plan B | less than 25 | less than 5% | 35% |
| plan B | 25 or more and less than 50 | less than 5% and 15% or more | 40% |
| plan B | 25 or more and less than 50 | less than 5% | 45% |

The Plan ID column is IDs for uniquely identifying service plans, and shows the service plans managed in the service plan management table of Table 1. The Total number of print sheets (range) column shows a range of the total number of print sheets printed during the contract period. The Current coverage rate (range) column shows a range of an average of the coverage rates in printing conducted during the contract period. The Display reference coverage rate column shows a coverage rate used for display in FIG. 10B, which is a coverage rate information screen described later. For example, it indicates that in the case where the plan ID of Table 1 is the service plan of plan A, the total number of print sheets is 25, and the current coverage rate is 7%, the display reference coverage rate is 40%.

In addition, in the printing service in the present embodiment, the CPU 301 of the server apparatus 300 registers contract information in the database 312 in accordance with registration of the user to the printing service.

The following Table 4 is an example of a contract information table, which is managed by the database 312.

TABLE 4
Contract information management table

| | | | | Start | Update | Cutoff |
|---|---|---|---|---|---|---|
| Contract ID | User ID | Plan ID | Device ID | date | date | date |
| contr A | user A | plan A | device X | 2023 Jan. 1 | 2024 Jan. 1 | 2023 Feb. 1 |
| contr B | user A | plan A | device Z | 2023 Jan. 1 | 2024 Jan. 1 | 2023 Feb. 1 |
| contr C | user B | plan B | device Y | 2023 Feb. 8 | 2024 Feb. 8 | 2023 Mar. 8 |

The Contract ID column is IDs for uniquely identifying contracts. The User ID column is IDs for uniquely identifying users. The Plan ID column is IDs for uniquely identifying service plans, is service plans managed in the service plan management table of Table 1, and shows service plans which the users have contracted. The device ID column is IDs for uniquely identifying devices, and shows image forming apparatuses 100 used in the service plans which the users have contracted. As the device IDs, for example, serial numbers of the image forming apparatuses 100 or the like are used. The Start date column shows dates when the users contracted and started the service plans. The Update date column is end dates of the periods for which the users have contracted the service plans, and show dates in which the users update the contract to continue or end the contract. The Cutoff date column shows dates when the next fees will be charged.

In addition, in the database 312 of the server apparatus 300, data of a printing history table of Table 5 and a coverage rate management table of Table 6, which will be described later, are set upon reception of print log information transmitted from the image forming apparatus 100.

The following Table 5 is an example of a printing history table, which is managed by the database 312.

TABLE 5
Printing history table

| Device | | | | Coverage | Reception date |
|---|---|---|---|---|---|
| ID | Document | Page | Type | rate | and time |
| device X | CCC.pdf | 1/1 | color | 20% | 2023 Jan. 2 12:00 |
| device X | ABC.pdf | 1/2 | color | 5% | 2023 Jan. 3 12:00 |
| device X | ABC.pdf | 2/2 | color | 70% | 2023 Jan. 3 12:00 |
| device Z | YYY.pdf | 1/1 | color | 17% | 2023 Jan. 5 12:00 |
| device Y | QWE.pdf | 1/1 | mono- | 10% | 2023 Jan. 20 19:00 |
| | | | chrome | | |
| device Y | QWE.pdf | 1/2 | mono- | 5% | 2023 Jan. 20 19:00 |
| | | | chrome | | |

The Device ID column is IDs for uniquely identifying devices, and shows the image forming apparatuses 100 which conducted printing. The Document column shows the name of a document which was printed. The Page column shows which page of the document was printed in the numerator, and shows the total number of pages of the document in the denominator. The Type column indicates in which print type the printing was conducted, color or monochrome. The Coverage rate column shows the use amount of the print material used on a printing sheet having a predetermined size. That is, it can also be said that the Coverage rate column shows the use amount of the printing material per sheet having a predetermined size. The Reception date and time column shows the date and time at which print data was received.

The following Table 6 is an example of a coverage rate management table, which is managed by the database 312.

TABLE 6
Coverage rate management table

| | Total | Sum of | Current | |
|---|---|---|---|---|
| | number of | coverage | coverage | Excess start |
| Device ID | print sheets | rates | rate | date |
| device X | 3 | 95.00% | 31.67% | 2023 Jan. 3 |
| device Z | 1 | 17.00% | 17.00% | — |
| device Y | 2 | 15.00% | 7.50% | — |

The Device ID column is IDs for uniquely identifying devices, and shows the image forming apparatuses 100 which conducted printing. The Total number of print sheets column shows a total number of print sheets which were printed after the registration to the printing service. The total number of print sheets of a target device ID coincides with the number of lines of the target device ID in the printing history table of Table 5. The Sum of coverage rates column shows the sum of coverage rates of prints conducted after the printing service registration. Note that the sum of coverage rates of a target device ID coincides with the sum of data in the Coverage rate column of the target device ID in the printing history table of Table 5. The Current coverage rate column shows a value obtained by dividing the sum of coverage rates by the total number of print sheets, and shows an average of the coverage rates of prints conducted by the image forming apparatus 100. The Excess start date column shows dates at which the current coverage rate exceeded a threshold specified in the contracted service plan, and is set at the timing at which the current coverage rate exceeded the threshold. Note that in the Excess start date column, “-” is set at the timing at which the current coverage rate fell below the above-described threshold.

### <Flow of Generation of Printing Advice>

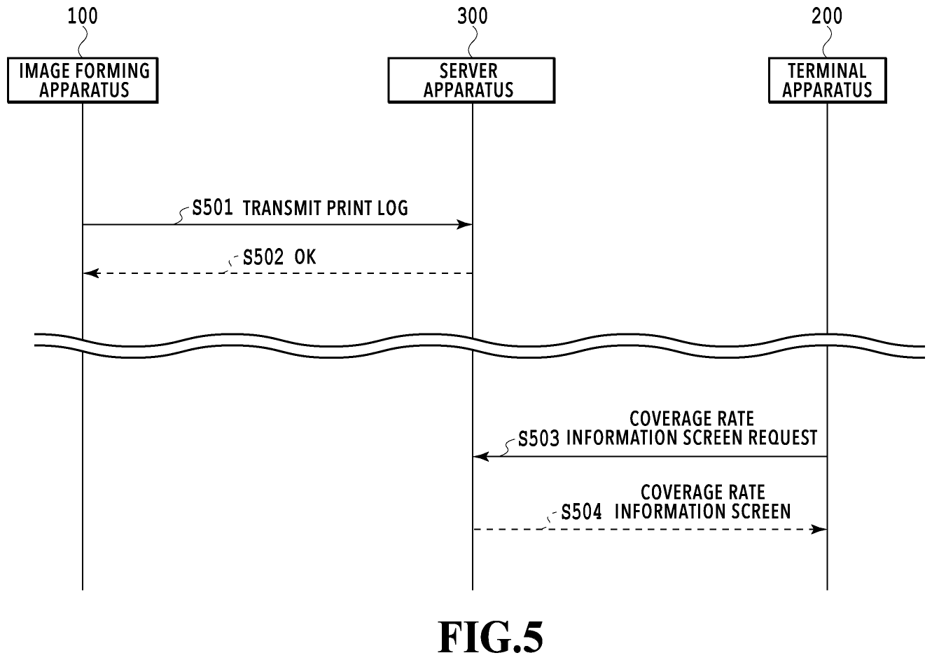

A process of generating an advice based on a relation between a coverage rate in printing executed by the image forming apparatus 100 and a threshold designated in a printing service provided by the server apparatus 300 after the registration to the printing service will be described with reference to FIG. 5 to FIG. 9. Specifically, a process of providing an advice on how many prints with what percentage of a coverage rate should be made hereinafter to suppress the coverage rate within a threshold designated in a printing service in the case where the coverage rate in printing conducted by the image forming apparatus 100 has exceeded the threshold after the registration to the printing service will be described. In addition, a process of providing an advice on up to how many prints with what percentage of a coverage rate can be made hereinafter without causing the coverage rate to exceed the threshold of the printing service in the case where the current coverage rate is below the threshold of the printing service will be described.

In addition, a series of processing shown in sequences and flowcharts given below is conducted by each CPU of the image forming apparatus 100, the terminal apparatus 200, and the server apparatus 300, developing program codes stored in a disk apparatus or the like in the RAM and executing the program codes. Alternatively, functions of some or all of the steps may be achieved by using hardware such as ASIC or an electronic circuit. Note that the sign “S” in the description of each process means a step in the sequence diagram. Hereinafter, the main body in each process is the CPUs included in the image forming apparatus 100, the terminal apparatus 200, and the server apparatus 300.

FIG. 5 is a flowchart showing a flow of generation processing of a printing advice. The processing shown in FIG. 5 is started in the case where the image forming apparatus 100 completed the execution of printing.

In S501, the image forming apparatus 100 transmits print log information to the server apparatus 300 after executing the printing. The print log information contains the device ID of the image forming apparatus 100 which conducted the printing, document information, page information, information on print materials such as the sheet and the used ink, the coverage rate of the print material, and the like. The print log information contains, for example, information indicating the number of sheets on which the image forming apparatus 100 formed images in a predetermined period and the use amount of the printing material required for the image formation.

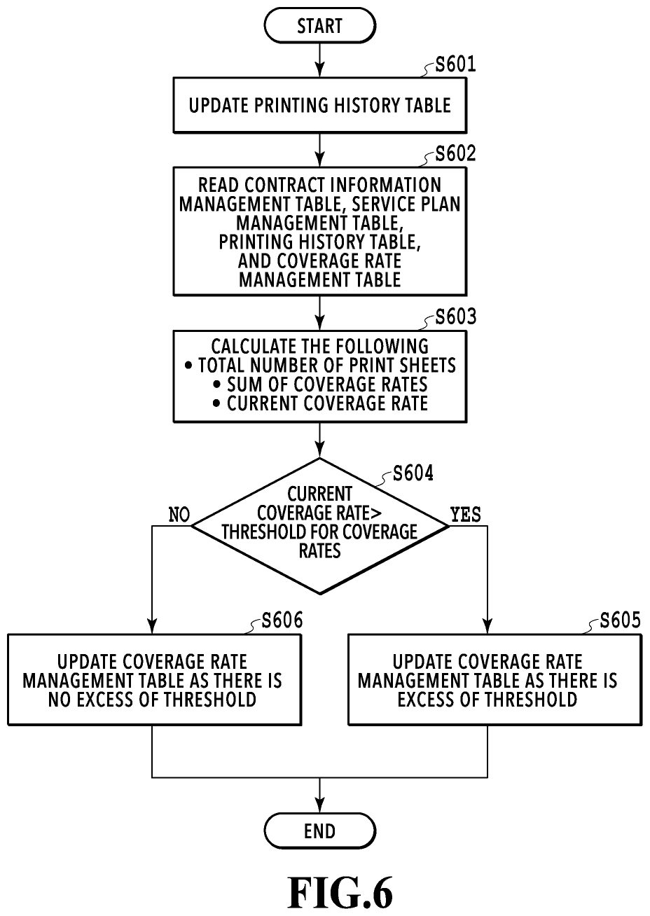

In S502, the server apparatus 300 updates the printing history table of Table 5 and the coverage rate management table of Table 6 based on a flow of FIG. 6, which will be described later, by using the received print log information, and returns a message that the reception of the print log information has been completed to the image forming apparatus 100.

### (Update Processing)

FIG. 6 is a flowchart showing a flow of the update processing of the printing history table and the coverage rate management table. The processing shown in FIG. 6 is started after the server apparatus 300 has received the print log information. Note that the update processing is executed by using the received print log information.

In S601, the server apparatus 300 adds the received print log information to the printing history table of Table 5 and stores the printing history table. In this way, the printing history table is updated.

In S602, the server apparatus 300 reads the contract information management table of Table 4, the service plan management table of Table 1, the printing history table of Table 5, and the coverage rate management table of Table 6. That is, the server apparatus 300 reads the contract information of the target device ID, which is contained in the received print log information from the contract information management table of Table 4. In addition, the server apparatus 300 reads plan information of the contract of the image forming apparatus 100 by using the plan ID, which is contained in the read contract information from the service plan management table of Table 1. In this way, the threshold for coverage rates is obtained. Moreover, the server apparatus 300 reads the printing history information and coverage rate information of the target device ID, which are contained in the received print log information from the printing history table of Table 5 and the coverage rate management table of Table 6.

In S603, the server apparatus 300 calculates and obtains the total number of print sheets (hereinafter, also referred to as the total number of sheets), the sum of coverage rates, and the current coverage rate. Specifically, the server apparatus 300 reads data which the target device ID matches from the printing history table of Table 5, and obtains the number of pieces of data thus read as the total number of print sheets. In addition, the server apparatus 300 obtains what is obtained by adding the coverage rates of the read data as the sum of coverage rates. Moreover, the server apparatus 300 obtains a value obtained by dividing the sum of coverage rates by the total number of print sheets as the current coverage rate. That is, it can also be said that the server apparatus 300 obtains the total number of print sheets and the use amount of the printing material, and derives the use amount of the printing material per a predetermined number of sheets from the obtained total number of print sheets and use amount of the printing material. Note that data shown in the coverage rate management table of Table 6 is updated by using the obtained total number of print sheets, sum of coverage rates, and current coverage rate.

In S604, the server apparatus 300 determines whether the current coverage rate calculated in S603 is larger than the threshold for coverage rates contained in the plan information read in S602. If the result of the determination is true (YES in S604), the processing proceeds to S605. If the result of the determination is false (NO in S604), the processing proceeds to S606.

In S605, the server apparatus 300 executes update processing in the case where the current coverage rate has exceeded the threshold for coverage rates contained in the plan information on the coverage rate management table of Table 6. That is, in the case where there is no data of coverage rate information read in S602, or the excess start date contained in the read coverage rate information is “-”, the server apparatus 300 sets current date and time in the excess start date, and updates the coverage rate information of the target device ID. Note that as the current date and time, for example, time information indicating the current date and time, which the server apparatus 300 holds, may be used, or time information indicating the current date and time, which the server apparatus 300 obtained from the outside may be used. In addition, the server apparatus 300 updates the coverage rate information of the target device ID by using the total number of print sheets, the sum of coverage rates, and the current coverage rate, which are calculated simultaneously in S603. After the processing of S605 is completed, the flow shown in FIG. 6 is ended.

In S606, the server apparatus 300 executes update processing in the case where the current coverage rate has not exceeded the threshold for coverage rates contained in the plan information on the coverage rate management table of Table 6. That is, the server apparatus 300 sets “-” in the excess start date, and updates data of the target device ID by using the excess start date, and the total number of print sheets, the sum of coverage rates, and the current coverage rate which are calculated in S603. After the processing of S606 is completed, the flow shown in FIG. 6 is ended.

### (Coverage Rate Management Screen)

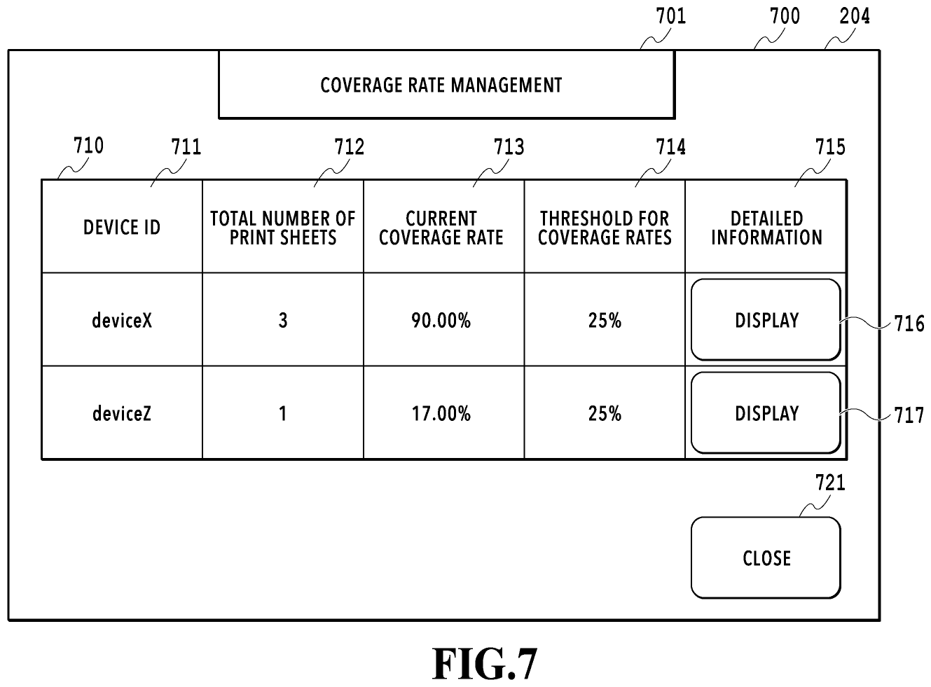

FIG. 7 is a diagram showing an example of a coverage rate management screen. A coverage rate management screen 700 is displayed on the display unit 204 of the terminal apparatus 200. The coverage rate management screen 700 is a screen through which information necessary for the display which is obtained from the server apparatus 300 is displayed on a portable screen of the user, which is not shown. Note that data transmitted to the server apparatus 300 for requesting acquisition of information necessary for the display of the coverage rate management screen 700 contains at least the user ID.

The coverage rate management screen 700 contains a page header 701, the coverage rate management table 710, and a closing button 721. The page header 701 shows an overview of a displayed content of the coverage rate management screen 700.

The coverage rate management table 710 contains information corresponding to each item of the device ID 711, the total number of print sheets 712, the current coverage rate 713, the threshold for coverage rates 714, and the detailed information 715.

The device ID 711 shows a device ID of the image forming apparatus which a display target user has contracted. In the device ID 711, the device ID of data associated with the user ID of the display target user in the contract information management table of Table 4 is displayed.

The total number of print sheets 712 shows the total number of print sheets printed during the contract period by the image forming apparatus of the device ID shown in device ID 711. The current coverage rate 713 shows a current coverage rate. The total number of print sheets 712 and the current coverage rate 713 show the total number of print sheets and the current coverage rate of data associated with the device ID shown on the coverage rate management screen 700, in the coverage rate management table of Table 6, respectively.

The threshold for coverage rates 714 shows a threshold for coverage rates of a plan in which the image forming apparatus of the device ID shown in device ID 711 has been contracted. In the threshold for coverage rates 714, the threshold for coverage rates in the service plan management table of Table 1, which is associated with the plan ID specified in the contract information management table of Table 4 by the user ID of the display target user and the device ID displayed on the coverage rate management screen 700 is displayed.

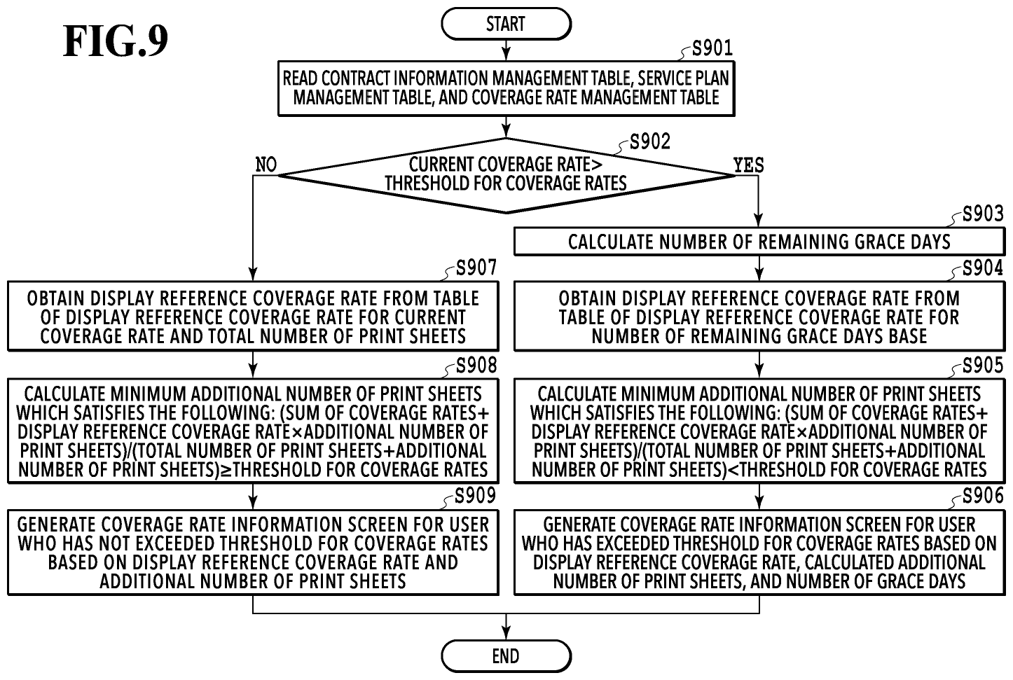

Display buttons 716 and 717 displayed in the detailed information 715 are buttons for displaying a screen which contains a printing advice related to the image forming apparatus of the device ID 711 displayed on the coverage rate management screen 700 and which is generated in a flow of FIG. 9 described later.

The closing button 721 is a button for receiving a user operation to close the coverage rate management screen 700 and display the portable screen of the user, which is not shown.

### (Display Processing of Coverage Rate Information Screen)

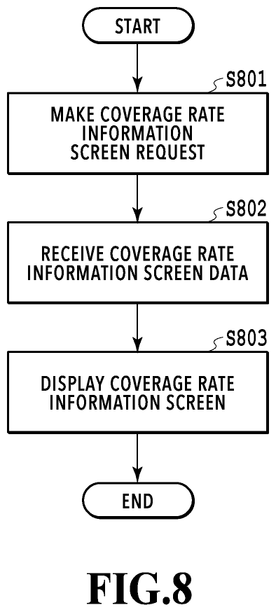

FIG. 8 is a flowchart showing a flow of display processing of the coverage rate information screens. The display processing of the coverage rate information screen is executed upon detection of a user operation of pressing one of the display buttons 716 and 717 corresponding to the detailed information 715 in the coverage rate management screen 700 which is displayed on the display unit 204 of the terminal apparatus 200.

In S801, the terminal apparatus 200 makes a coverage rate information screen request to the server apparatus 300. Transmission data of the coverage rate information screen request contains at least a device ID associated with a pressed display button of the detailed information 715. For example, in the case where the user operation of pressing the display button 716 is detected, the transmission data of the coverage rate information screen request contains device X, which is a device ID associated with the display button 716.

Referring back to the sequence of FIG. 5, since the processing of S503 is the same as the processing of S801, detailed description thereof is omitted. Note that before the processing of S503 is executed, the coverage rate management screen 700 has been displayed on the display unit 204 of the terminal apparatus 200. In S504, the server apparatus 300 which has received the coverage rate information screen request generates a coverage rate information screen containing a printing advice in accordance with the flow of FIG. 9, which will be described later, and returns the generated screen to the terminal apparatus 200. That is, the server apparatus 300 outputs a coverage rate information screen containing a printing advice, which is information for appropriately maintaining the use amount of the printing material per a predetermined number of sheets, and transmits the coverage rate information screen to the terminal apparatus 200 which the user uses. After the processing of S504 is completed, the flow shown in FIG. 5 is ended.

Referring back to the description of FIG. 8, in S802, the terminal apparatus 200 receives the coverage rate information screen transmitted back from the server apparatus 300. In S803, the terminal apparatus 200 displays the coverage rate information screen received in S802 on the display unit 204. After the processing of S803 is completed, the flow shown in FIG. 8 is ended.

### (Generation Processing of Coverage Rate Information Screen)

FIG. 9 is a flowchart showing a flow of generation processing of the coverage rate information screen. The coverage rate information screen is a screen which is generated based on a received coverage rate information screen request, and contains a printing advice.

In S901, the server apparatus 300 reads the contract information management table of Table 4, the service plan management table of Table 1, and the coverage rate management table of Table 6. That is, the server apparatus 300 reads contract information of a target device ID contained in the received coverage rate information screen request from the contract information management table of Table 4. In addition, the server apparatus 300 reads plan information of a plan ID contained in the read contract information from the service plan management table of Table 1. Moreover, the server apparatus 300 reads coverage rate information of a target device ID contained in the received coverage rate information screen request from the coverage rate management table of Table 6.

In S902, the server apparatus 300 determines whether a current coverage rate contained in the coverage rate information read in S901 is larger than a threshold for coverage rates set in the plan information read in S901. If the result of the determination is true (YES in S902), the processing proceeds to S903. On the other hand, if the result of the determination is false (NO in S902), the processing proceeds to S907.

In S903, the server apparatus 300 calculates the number of remaining grace days which indicates a remaining grace period. That is, the server apparatus 300 calculates a difference between the current date and an excess start date contained in the coverage rate information read in S901 as the number of elapsed days of excess, and obtains the number of days by subtracting the number of elapsed days of excess from the number of grace days of excess contained in the plan information read in S901 as the number of remaining grace days. Note that the number of elapsed days of excess is also referred to as an elapsed period for excess.

In S904, the server apparatus 300 obtains a display reference coverage rate from the table of a display reference coverage rate for the number of remaining grace days base of Table 2, by using a plan ID contained in the plan information read in S901 and the number of remaining grace days calculated in S903. It can also be said that the display reference coverage rate is the use amount of the printing material per a predetermined number of sheets on which image formation can be performed. That is, it can also be said that the display reference coverage rate is a reference use amount of the printing material per a predetermined number of sheets, which is associated with a plan of the subscription service, a remaining grace period, a total number of sheets on which image formation has been performed, and a derived current coverage rate.

In S905, the server apparatus 300 calculates a minimum additional number of print sheets which satisfies formula 1 “(the sum of coverage rates+the display reference coverage rate×the additional number of print sheets)/(the total number of print sheets+the additional number of print sheets)<the threshold for coverage rates”. Specifically, the server apparatus 300 plugs in 1, 2, 3, . . . for the additional number of print sheets of formula 1, and specifies a minimum additional number of print sheets which satisfies the condition of formula 1. Hereinafter, the minimum additional number of print sheets thus specified is referred to as an additional number of print sheets. Note that the sum of coverage rates and the total number of print sheets of formula 1 are data contained in the coverage rate information read in S901. The display reference coverage rate of formula 1 is the display reference coverage rate obtained in S904. In addition, the threshold for coverage rates of formula 1 is the threshold for coverage rates contained in the plan information read in S901. That is, the number of sheets on which image formation can be performed can be obtained from a sum of the use amounts (coverage rates) of the printing material per a predetermined number of sheets, the reference use amount of the printing material per the predetermined number of sheets, the total number of sheets on which image formation was performed, and the threshold for coverage rates. It can also be said that the threshold for coverage rates is an upper limit of the use amount of the printing material per a predetermined number of sheets in a contract in the subscription service.

In S906, the server apparatus 300 generates a coverage rate information screen for a user who has exceeded the threshold for coverage rates, which will be described in detail later, based on the display reference coverage rate, the calculated additional number of print sheets, and the number of grace days. That is, the server apparatus 300 generates a UI screen which is determined based on the use amount of the printing material per a predetermined number of sheets, and shows the number of sheets on which image formation can be performed and the use amount of the printing material per the predetermined number of sheets for suppressing the use amount within the upper limit of the use amount of the printing material per the predetermined number of sheets in the contract in the subscription service. After the processing of S906 is completed, the flow shown in FIG. 9 is ended.

### (Coverage Rate Information Screen for User Who has Exceeded Threshold for Coverage Rates)

FIG. 10A is a diagram showing an example of the coverage rate information screen for a user who has exceeded the threshold for coverage rates. A coverage rate information screen 1010 for a user who has exceeded the threshold for coverage rates is a UI screen, and is displayed on the display unit 204 of the terminal apparatus 200. The coverage rate information screen 1010 for a user who has exceeded the threshold for coverage rates contains a page header 1011 and a current coverage rate status 1012. The coverage rate information screen 1010 for a user who has exceeded the threshold for coverage rates further contains a display reference coverage rate 1013, a printing advice 1014, an image title 1015, a print image example 1016, and a closing button 1017.

The page header 1011 is displayed on an upper portion of the coverage rate information screen 1010 for a user who has exceeded the threshold for coverage rates, and contains the device ID of the displayed image forming apparatus 100. The current coverage rate status 1012 shows the current status of the coverage rate of the image forming apparatus 100. In the current coverage rate status 1012, a message that the coverage rate has exceeded the threshold for coverage rates set in the contracted plan, and a message that the coverage rate needs to be reduced within the number of remaining grace days calculated in S903 are displayed. The display reference coverage rate 1013 shows the display reference coverage rate obtained in S904.

The printing advice 1014 contains display of the additional number of print sheets calculated in S905, and indicates that it is possible to cause the coverage rate to fall below the threshold for coverage rates set in the contracted plan by printing the additional number of print sheets at the display reference coverage rate 1013. That is, it can also be said that the coverage rate information screen 1010 for a user who has exceeded the threshold for coverage rates contains a region showing an advice corresponding to the use amount of the printing material.

The image title 1015 is a title of an image 1016 which will be described later, and contains the display reference coverage rate 1013. The image 1016 is an image showing an example of printing at the display reference coverage rate 1013. That is, it can also be said that the image 1016 is an image-formation image in the case where an image is formed with the use amount of the printing material per the predetermined number of sheets. The image 1016 contains an explanatory text for the image 1016. In addition, the image 1016 contains an explanatory text for the use amount of the printing material per the predetermined number of sheets. The closing button 1017 is a button for receiving a user operation to close the coverage rate information screen 1010 for a user who has exceeded the threshold for coverage rates and display the portable screen of the user, which is not shown.

Referring back to the description of FIG. 9, in S907, the server apparatus 300 obtains a display reference coverage rate from the table of a display reference coverage rate for the current coverage rate and the total number of print sheets of Table 3. To obtain the display reference coverage rate, the plan ID contained in the plan information read in S901 and the total number of print sheets and the current coverage rate contained in the coverage rate information read in S901 are used. That is, the use amount of the printing material per a predetermined number of sheets on which image formation can be performed is a reference use amount of the printing material per a predetermined number of sheets, which is associated with a plan of the subscription service, a total number of sheets on which image formation has been performed, and the use amount of the printing material per the predetermined number of sheets.

In S908, the server apparatus 300 calculates a minimum additional number of print sheets which satisfies formula 2 “(the sum of coverage rates+the display reference coverage ratexthe additional number of print sheets)/(the total number of print sheets+the additional number of print sheets)≥the threshold for coverage rates”. Specifically, the server apparatus 300 plugs in 1, 2, 3, . . . for the additional number of print sheets of formula 2, and specifies a minimum additional number of print sheets which satisfies the condition of formula 2. The minimum additional number of print sheets thus specified is referred to as an additional number of print sheets below. Note that the sum of coverage rates and the total number of print sheets of formula 2 are data contained in the coverage rate information read in S901. The display reference coverage rate of formula 2 is the display reference coverage rate obtained in S907. In addition, the threshold for coverage rates of formula 2 is the threshold for coverage rates contained in the plan information read in S901. That is, the number of sheets on which image formation can be performed can be obtained from a sum of the use amounts of the printing material per a predetermined number of sheets, the reference use amount of the printing material per the predetermined number of sheets, the total number of sheets on which image formation was performed, and the threshold for coverage rates.

In S909, the server apparatus 300 generates a coverage rate information screen for a user who has not exceeded the threshold for coverage rates, which will be described in detail later, based on the display reference coverage rate and the calculated additional number of print sheets. That is, the server apparatus 300 generates a UI screen which is determined based on the use amount of the printing material per a predetermined number of sheets and shows the number of sheets on which image formation can be performed and the use amount of the printing material per the predetermined number of sheets for suppressing the use amount within the upper limit of the use amount of the printing material per the predetermined number of sheets in the contract in the subscription service. After the processing of S909 is completed, the flow shown FIG. 9 is ended.

### (Coverage Rate Information Screen for User Who has not Exceeded Threshold for Coverage Rates)

FIG. 10B is a diagram showing an example of the coverage rate information screen for a user who has not exceeded the threshold for coverage rates. A coverage rate information screen 1020 for a user who has not exceeded the threshold for coverage rates is a UI screen, and is displayed on the display unit 204 of the terminal apparatus 200. The coverage rate information screen 1020 for a user who has not exceeded the threshold for coverage rates contains a page header 1021 and a current coverage rate status 1022. The coverage rate information screen 1020 for a user who has not exceeded the threshold for coverage rates further contains a display reference coverage rate 1023, a printing advice 1024, an image title 1025, a print image example 1026, and a closing button 1027.

The page header 1021 is displayed on an upper portion of the coverage rate information screen 1020 for a user who has not exceeded the threshold for coverage rates, and contains the device ID of the displayed image forming apparatus 100. The current coverage rate status 1022 shows the current status of the coverage rate of the image forming apparatus 100. In the current coverage rate status 1022, a message that the threshold for coverage rates set in the contracted plan has not been reached yet is shown. The display reference coverage rate 1023 shows the display reference coverage rate obtained in S907.

The printing advice 1024 contains display of the number of sheets obtained by subtracting 1 from the additional number of print sheets calculated in S908, and indicates that it is possible to conduct printing within the threshold for coverage rates set in the contracted plan even in the case of printing the number of print sheets at the display reference coverage rate 1023. Note that in the case where the number of sheets obtained by subtracting 1 from the additional number of print sheets calculated in S908 is less than 0, 0 is displayed as the number of sheets. That is, it can also be said that the coverage rate information screen 1020 for a user who has not exceeded the threshold for coverage rates contains a region showing an advice corresponding to the use amount of the printing material.

The image title 1025 is a title of an image 1026 which will be described later, and contains the display reference coverage rate 1023. The image 1026 is an image showing an example of printing at the display reference coverage rate 1023. That is, it can also be said that the image 1026 is an image-formation image in the case where an image is formed with the use amount of the printing material per the predetermined number of sheets. The image 1026 contains an explanatory text for the image 1026. In addition, the image 1026 contains an explanatory text for the use amount of the printing material per the predetermined number of sheets. The closing button 1027 is a button for receiving a user operation to close the coverage rate information screen 1020 for a user who has not exceeded the threshold for coverage rates and display the portable screen of the user, which is not shown.

### <Effects of Present Embodiment>

According to the present embodiment, in the case where a current coverage rate has exceeded a specified threshold of the printing service, it becomes possible to display a printing advice indicating how many prints with what percentage of a coverage rate should be made for suppressing the coverage rate within the threshold. This makes it possible to encourage a user to reduce printing at an excessive coverage rate and to reduce a risk that components involved in the printing processing of the image forming apparatus 100 are overused. In addition, in the case where there is a penalty relating to a coverage rate by the printing service provider, it is possible to avoid such a penalty.

In addition, in the case where the current coverage rate is below the threshold of the printing service, it is possible to display a printing advice indicating how many prints with what degree of a coverage rate can be made without causing the coverage rate to exceed the threshold. This makes it possible to prompt the efficient use of resources without causing printing at an excessive coverage rate. That is, it is possible to present information to the user of the subscription service for appropriately maintaining the use amount of the printing material per a predetermined number of sheets.

### Second Embodiment

In the first embodiment, a mode for generating a printing advice based on a previously set coverage rate has been described. In the present embodiment, a mode for providing a printing advice based on a coverage rate in the latest printing will be described. Note that in the present embodiment, the description of contents common with the first embodiment is omitted as appropriate, and points different from the first embodiment will be mainly described.

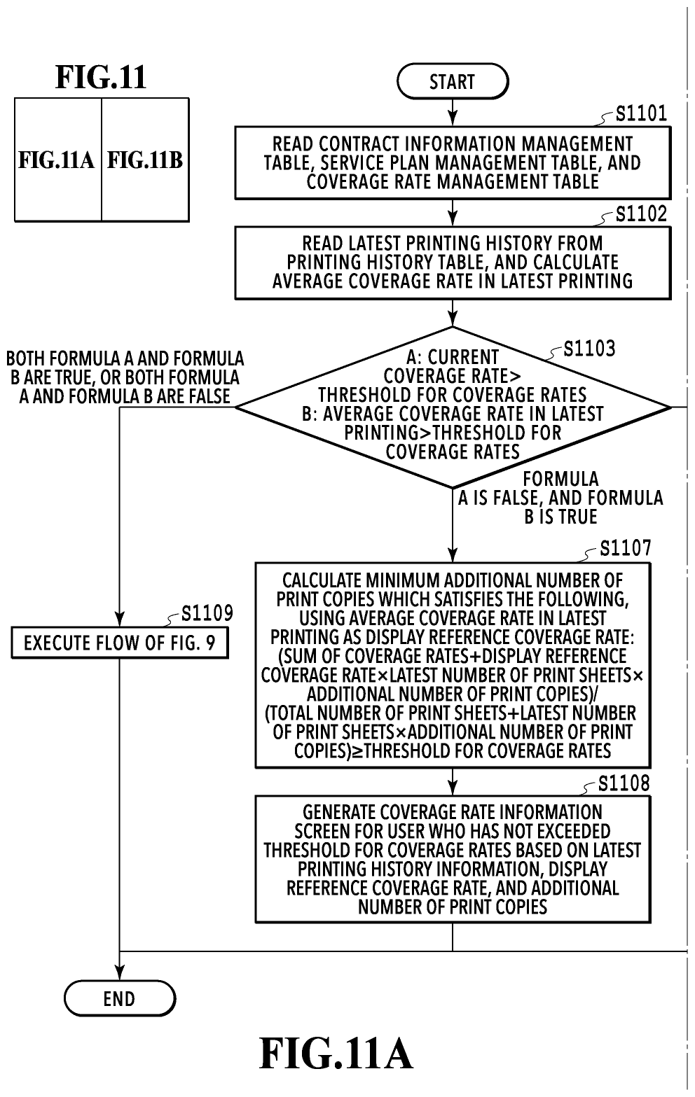

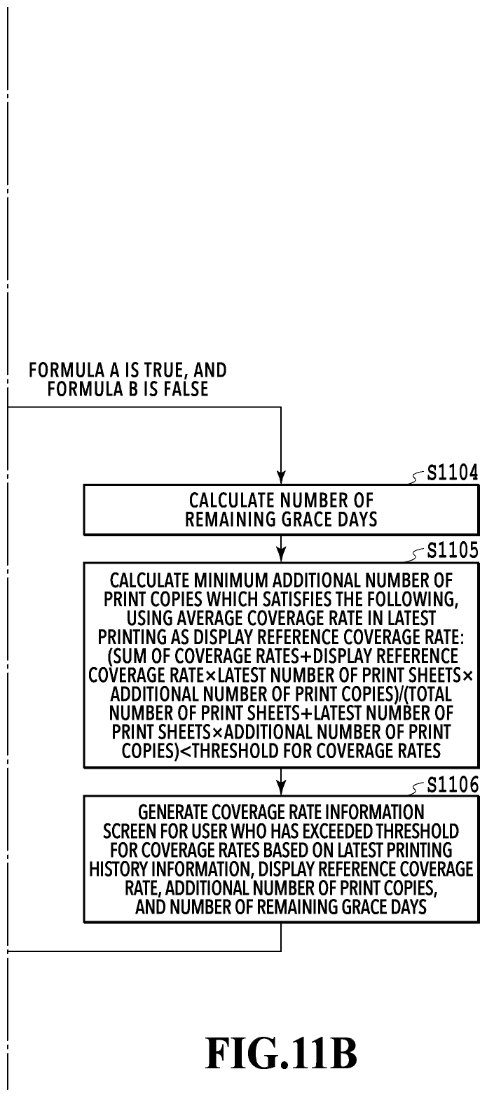

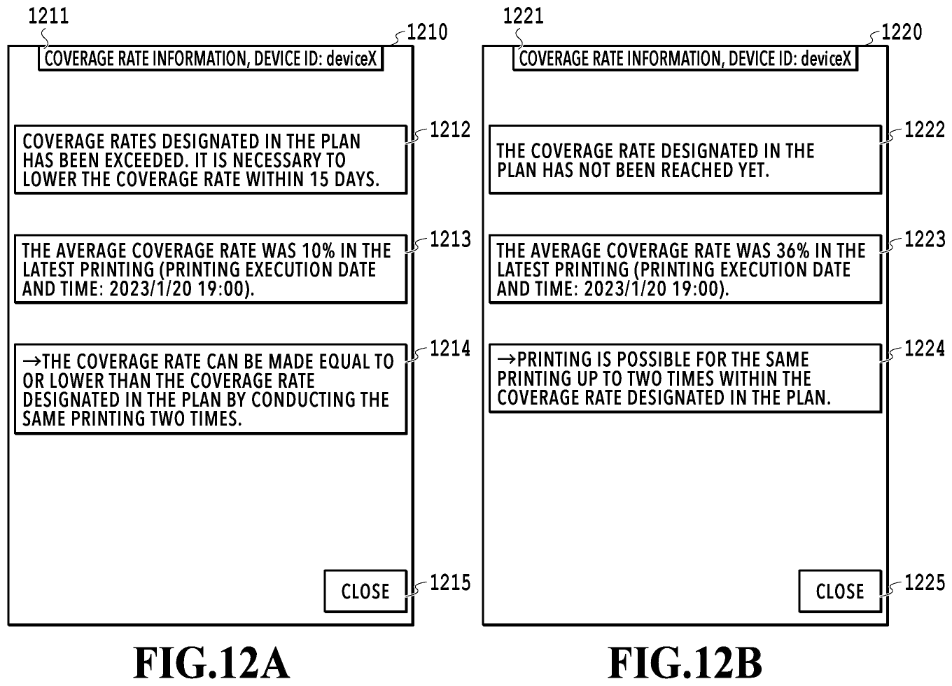

In the present embodiment, the server apparatus 300 which has received a coverage rate information screen request in S504 of FIG. 5 generates coverage rate information screens containing printing advices using coverage rates in the latest printing in FIGS. 12A and 12B, which will be described later, in accordance with a flow of FIG. 11, which will be described later. Then, the server apparatus 300 returns the generated screen to the terminal apparatus 200. That is, the server apparatus 300 transmits the generated coverage rate information screen containing the printing advice using the coverage rate in the latest printing to the terminal apparatus 200. After the processing of S504 is completed, the flow shown in FIG. 5 is ended. However, in the case where an advice cannot be generated by using the coverage rate in the latest printing, which will be described later, the server apparatus 300 generates the coverage rate information screens containing the printing advices of FIGS. 10A and 10B like the first embodiment.

### (Generation Processing of Coverage Rate Information Screens)

FIG. 11A and FIG. 11B are flowcharts showing a flow of generation processing of coverage rate information screens. The coverage rate information screen is a screen which is generated based on a received coverage rate information screen request, and which contains a printing advice using a coverage rate in the latest printing.

Since the processing of S1101 is the same as the processing of S901, detailed description thereof is omitted.

In S1102, the server apparatus 300 reads the latest printing history of the target device ID from the printing history table of Table 5. The latest printing history is a data group of which the reception date and time are the latest date and time. The server apparatus 300 obtains an average value of the coverage rates from the sum of the coverage rates of the read latest printing history. For example, the case where the target device ID is “device X” will be described. The reception date and time is the latest date and time (23/1/3 12:00), and the coverage rate “5%” of the page “½” of the document “ABC.pdf” and the coverage rate “70%” of the pages “2/2” of the document “ABC.pdf” are read. Then, from the sum of 5% and 70%, 37.5% is obtained as an average value of the coverage rates. Hereinafter, an average value of coverage rates is referred to as an average coverage rate in the latest printing.

In S1103, the server apparatus 300 evaluates formula A “the current coverage rate>the threshold for coverage rates” and formula B “the average coverage rate in the latest printing>the threshold for coverage rates”. Note that the current coverage rate is a current coverage rate contained in the coverage rate information read in S1101. The threshold for coverage rates is a threshold for coverage rates set in the plan information contained in the contract information read in S1101. If the result of determination that both formula A and formula B are true is obtained, or if the result of determination that both formula A and formula B are false is obtained, the processing proceeds to S1109. If the result of determination that formula A is false and formula B is true is obtained, the processing proceeds to S1104. If the result of determination that formula A is true and formula B is false is obtained, the processing proceeds to S1107.

Since the processing of S1104 is the same as the processing of S903, detailed description thereof is omitted.

In S1105, the server apparatus 300 calculates a minimum additional number of print copies which satisfies formula 3 using the average coverage rate in the latest printing calculated in S1102 as a display reference coverage rate. Formula 3 is “(the sum of coverage rates+the display reference coverage ratexthe latest number of print sheets×the additional number of print copies)/(the total number of print sheets+the latest number of print sheets×the additional number of print copies)<the threshold for coverage rates”. Specifically, the server apparatus 300 plugs in 1, 2, 3, . . . for the additional number of print copies of formula 3, and specifies a minimum additional number of print copies which satisfies the condition of formula 3. Hereinafter, the minimum additional number of print copies thus specified is referred to as the additional number of print copies. Note that the sum of coverage rates and the total number of print sheets of formula 3 are data contained in the coverage rate information read in S1101. The latest number of print sheets of formula 3 is the number of pieces of data of the latest printing history read in S1102. In addition, the threshold for coverage rates of formula 3 is the threshold for coverage rates contained in the plan information read in S1101. That is, the use amount of the printing material per a predetermined number of sheets on which image formation can be performed is an average of the latest use amounts of the printing material. In addition, it can also be said that the number of copies on which image formation can be performed can be obtained from the derived sum of coverage rates, the reference use amount of the printing material per a predetermined number of sheets, the total number of sheets on which image formation was performed in the last time, the total number of sheets on which image formation was performed, and the threshold for coverage rates.

In S1106, the server apparatus 300 generates a coverage rate information screen for a user who has exceeded the threshold for coverage rates, which will be described in detail later. That is, it can also be said that the server apparatus 300 generates a UI screen containing a remaining grace period obtained from the elapsed period for excess and the predetermined grace period. After the processing of S1106 is completed, the flow shown in FIG. 11 is ended.

### (Coverage Rate Information Screen for User Who has Exceeded Threshold for Coverage Rates)

FIG. 12A is a diagram showing an example of the coverage rate information screen for a user who has exceeded the threshold for coverage rates. A coverage rate information screen 1210 for a user who has exceeded the threshold for coverage rates is a UI screen, and is displayed on the display unit 204 of the terminal apparatus 200. The coverage rate information screen 1210 for a user who has exceeded the threshold for coverage rates contains a page header 1211, a current coverage rate status 1212, an average coverage rate 1213, a printing advice 1214, and a closing button 1215.

Since the page header 1211 and the current coverage rate status 1212 are the same as the page header 1011 and the current coverage rate status 1012 shown in FIG. 10A, detailed description thereof is omitted. Note that it can also be said that the coverage rate information screen 1210 for a user who has exceeded the threshold for coverage rates contains a region showing an advice corresponding to the use amount of the printing material.

The average coverage rate 1213 shows a latest printing execution date and time and an average coverage rate in the printing. The latest printing execution date and time shows a printing date and time contained in the latest printing history read in S1102. The average coverage rate shows a display reference coverage rate in the latest printing calculated in S1102.

The printing advice 1214 contains the additional number of print copies calculated in S1105, and indicates that it is possible to cause the coverage rate to fall below the threshold for coverage rates set in the contracted plan by printing that number of print copies at the same average coverage rate as in the latest printing. That is, it can also be said that the coverage rate information screen 1210 for a user who has exceeded the threshold for coverage rates contains a region showing an image formation condition for making the use amount equal to or lower than the upper limit of the use amount of the printing material per a predetermined number of sheets in the contract in the subscription service. Since the closing button 1215 is the same as the closing button 1017, detailed description thereof is omitted.

Referring back to the flow of FIG. 11, in S1107, the server apparatus 300 calculates a minimum additional number of print copies which satisfies formula 4 using the average coverage rate in the latest printing calculated in S1102 as a display reference coverage rate. Formula 4 is “(the sum of coverage rates+the display reference coverage ratexthe latest number of print sheets×the additional number of print copies)/(the total number of print sheets+the latest number of print sheets×the additional number of print copies)≥the threshold for coverage rates”. Specifically, the server apparatus 300 plugs in 1, 2, 3, . . . for the additional number of print copies of formula 4, and specifies a minimum additional number of print copies which satisfies the condition of formula 4. Hereinafter, the minimum additional number of print copies thus specified is referred to as the additional number of print copies. Note that the sum of coverage rates and the total number of print sheets of formula 4 are data contained in the coverage rate information read in S1101. The latest number of print sheets of formula 4 is data of the latest printing history read in S1102. In addition, the threshold for coverage rates of formula 4 is the threshold for coverage rates contained in the plan information read in S1101. That is, the use amount of the printing material per a predetermined number of sheets on which image formation can be performed is an average of the latest use amounts of the printing material. It can also be said that the number of copies on which image formation can be performed can be obtained from the derived sum of coverage rates, the reference use amount of the printing material per a predetermined number of sheets, the total number of sheets on which image formation was performed in the last time, the total number of sheets on which image formation was performed, and the threshold for coverage rates.

In S1108, the server apparatus 300 generates a coverage rate information screen for a user who has not exceeded the threshold for coverage rates, which will be described in detail later, based on the latest printing history information, the display reference coverage rate, and the additional number of print copies. That is, the server apparatus 300 generates a UI screen which is determined based on the use amount of the printing material per a predetermined number of sheets, and shows the number of sheets on which image formation can be performed and the use amount of the printing material per the predetermined number of sheets for suppressing the use amount within the upper limit of the use amount of the printing material per the predetermined number of sheets in the contract in the subscription service. After the processing of S1108 is completed, the flow shown in FIG. 11 is ended.

### (Coverage Rate Information Screen for User Who has not Exceeded Threshold for Coverage Rates)

FIG. 12B is a diagram showing an example of the coverage rate information screen for a user who has not exceeded the threshold for coverage rates. A coverage rate information screen 1220 for a user who has not exceeded the threshold for coverage rates is a UI screen, and is displayed on the display unit 204 of the terminal apparatus 200. The coverage rate information screen 1220 for a user who has not exceeded the threshold for coverage rates contains a page header 1221, a current coverage rate status 1222, an average coverage rate 1223, a printing advice 1224, and a closing button 1225.

Since the page header 1221 and the current coverage rate status 1222 are the same as the page header 1021 and the current coverage rate status 1022 shown in FIG. 10B, detailed description thereof is omitted. In addition, since the average coverage rate 1223 is the same as the average coverage rate 1213 shown in FIG. 12A, detailed description thereof is omitted.

The printing advice 1224 contains display of the number of copies obtained by subtracting 1 from the additional number of print copies calculated in S1107, and indicates that it is possible to conduct printing within the threshold for coverage rates set in the contracted plan even in the case of conducting printing the number of print copies in the same manner as the last time. That is, it can also be said that the coverage rate information screen 1220 for a user who has exceeded the threshold for coverage rates contains a region showing an image formation condition for making the use amount equal to or lower than the upper limit of the use amount of the printing material per a predetermined number of sheets in the contract in the subscription service. Note that in the case where the number of copies obtained by subtracting 1 from the additional number of print copies calculated in S1107 is less than 0, 0 is displayed as the number of copies. Since the closing button 1225 is the same as the closing button 1215, detailed description thereof is omitted.

Referring back to the flow of FIG. 11, in S1109, the server apparatus 300 executes the flow of FIG. 9. After the processing of S1109 is completed, the flow shown in FIG. 11 is ended.

In the case where both formula A and formula B are true, both the current coverage rate and the average coverage rate in the latest printing have exceeded the threshold for coverage rates. Hence, it is necessary to provide an advice for causing the coverage rate to fall below the threshold for coverage rates. However, since a printing advice for causing the coverage rate in the latest printing to fall below the threshold for coverage rates cannot be provided, it is necessary to provide a printing advice with a coverage rate set in advance like the first embodiment. Hence, the processing of FIG. 9 is executed to generate the coverage rate information screen shown in FIG. 10A.

In addition, in the case where both formula A and formula B are false, the current coverage rate and the average coverage rate in the latest printing are below the threshold for coverage rates, and a printing advice cannot be provided similarly. Hence, the processing of FIG. 9 is executed to generate the coverage rate information screen shown in FIG. 10B. Note that in the flow of FIG. 9 in the present embodiment, since the processing of S901 is the same as the processing of S1101, the processing of S901 is skipped.

### <Effect of Present Embodiment>

According to the present embodiment, it becomes possible to provide a printing advice to a user based on the latest print data in the case where the user has conducted printing. This makes it easy for the user to execute printing in conformity with the printing advice.

### Third Embodiment

In the first embodiment, the mode on the assumption that the number of grace days of excess is set in the provided service for the printing advice for a user who has exceeded the threshold has been described. In the present embodiment, a mode for generating a page of a printing advice based on the number of elapsed days of excess will be described. Note that in the present embodiment, the description of contents common with the first embodiment is omitted as appropriate, and points different from the first embodiment will be mainly described.

The server apparatus 300 in the present embodiment manages a table of a display reference coverage rate for the number of elapsed days of excess base of Table 7, which will be described in detail later, instead of the table of a display reference coverage rate for the number of remaining grace days base of Table 2.

The following Table 7 is an example of the table of a display reference coverage rate for the number of elapsed days of excess base, which is managed by the database 312.

TABLE 7
Table of display reference coverage rate for
the number of elapsed days of excess base

| | Number of elapsed days | Display reference |
|---|---|---|
| Plan ID | of excess (period) | coverage rate |
| plan A | 40 or more | 20% |
| plan A | less than 40 and 20 or more | 15% |
| plan A | less than 20 and 10 or more | 10% |
| plan A | less than 10 | 5% |
| plan B | 30 or more | 15% |
| plan B | less than 30 and 10 or more | 10% |
| plan B | less than 10 | 5% |

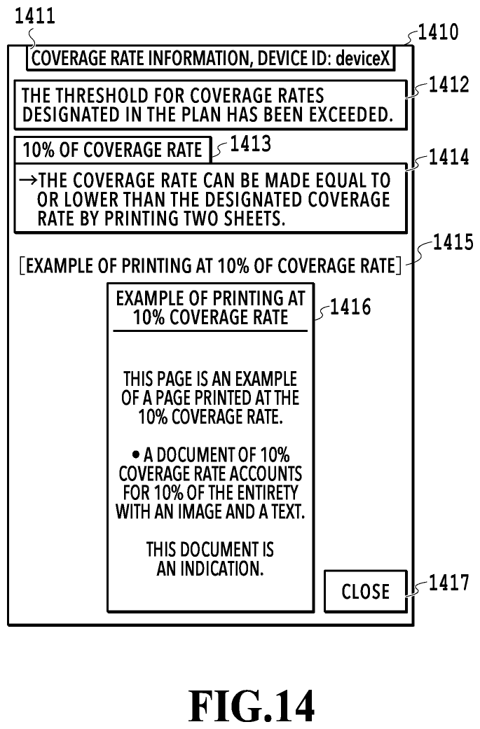

The Plan ID column is IDs for uniquely identifying service plans, and shows the service plans managed in the service plan management table of Table 1. The Number of elapsed days of excess (period) column shows the number of elapsed days after the threshold for each service plan set in the service plan management table of Table 1 was exceeded. The Display reference coverage rate column shows a coverage rate used for display in FIG. 14, which is a coverage rate information screen, which will be described later.

### (Generation Processing of Coverage Rate Information Screen)

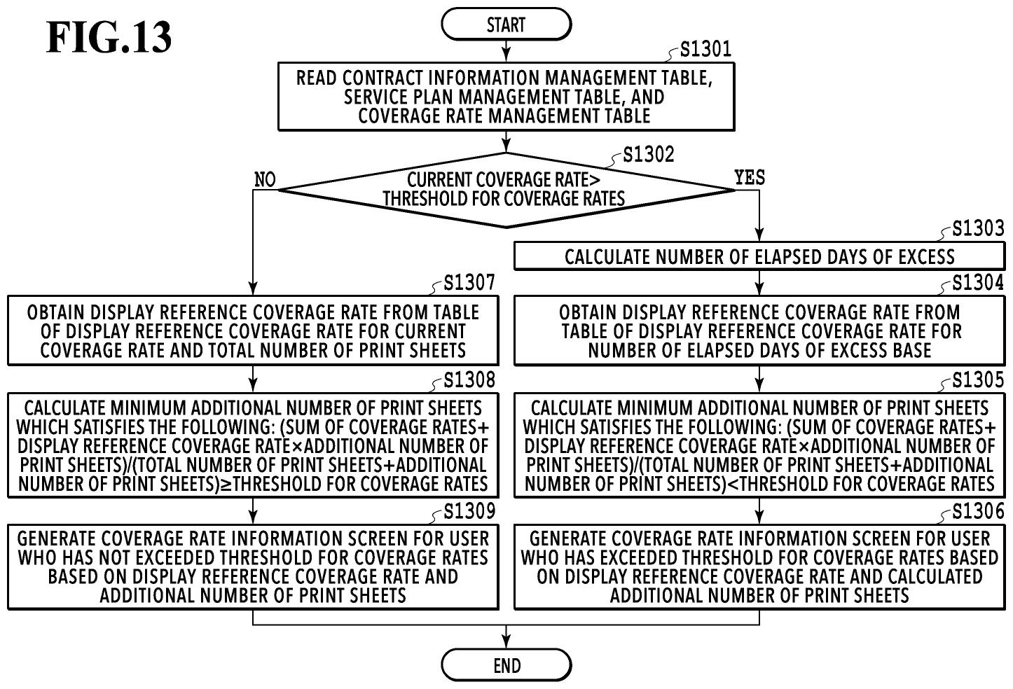

FIG. 13 is a flowchart showing a flow of generation processing of the coverage rate information screen. The coverage rate information screen is generated based on a received coverage rate information screen request. Differences from FIG. 9 will be mainly described. S1303 is processing alternative to S903, S1304 is processing alternative to S904, and S1306 is processing alternative to S906. S1301, S1302, S1305, and S1307 to S1309 shown in FIG. 13 are the same processing as S901, S902, S905, and S907 to S909 shown FIG. 9, respectively, and detailed description thereof is omitted.

In S1303, the server apparatus 300 calculates the number of elapsed days of excess. That is, the server apparatus 300 calculates a difference between the current date and an excess start date contained in the coverage rate information read in S1301, and obtains the calculated difference as the number of elapsed days of excess.

In S1304, the server apparatus 300 obtains a display reference coverage rate from a plan ID of a contracted plan of the target device ID and the number of elapsed days of excess from the table of a display reference coverage rate for the number of elapsed days of excess base of Table 7. Specifically, the server apparatus 300 obtains the display reference coverage rate by using the plan ID contained in the plan information read in S1301 and the number of elapsed days of excess calculated in S1303 from the table of a display reference coverage rate for the number of elapsed days of excess base of Table 7. That is, the use amount of the printing material per a predetermined number of sheets on which image formation can be performed is a reference use amount of the printing material per a predetermined number of sheets, which is associated with a plan of the subscription service and an elapsed period for excess. The number of sheets on which image formation can be performed can be obtained from the derived sum of coverage rates, the reference use amount of the printing material per the predetermined number of sheets, the total number of sheets on which image formation was performed, and a threshold for coverage rates.

In S1306, the server apparatus 300 generates a coverage rate information screen for a user who has exceeded the threshold for coverage rates, which will be described in detail later, based on a display reference coverage rate and the calculated additional number of print sheets. After the processing of S1306 is completed, the flow shown in FIG. 13 is ended.

### (Coverage Rate Information Screen for User Who has Exceeded Threshold for Coverage Rates)

FIG. 14 is a diagram showing an example of the coverage rate information screen for a user who has exceeded the threshold for coverage rates. A coverage rate information screen 1410 for a user who has exceeded the threshold for coverage rates is a UI screen, and is displayed on the display unit 204 of the terminal apparatus 200. The screen 1410 for a user who has exceeded the threshold for coverage rates contains a page header 1411 and a current coverage rate status 1412. The screen 1410 for a user who has exceeded the threshold for coverage rates further contains a display reference coverage rate 1413, a printing advice 1414, an image title 1415, a print image example 1416, and a closing button 1417. Note that among the elements contained in the screen 1410 shown in FIG. 14, the elements 1411 and 1413 to 1417 except for the current coverage rate status 1412 are the same as the elements 1011 and 1013 to 1017 contained in the screen 1010 shown in FIG. 10A, respectively, and detailed description thereof is omitted.

The current coverage rate status 1412 is alternative to the current coverage rate status 1012 shown in FIG. 10A. The current coverage rate status 1412 shows the current status of the coverage rate of the image forming apparatus 100, and only indicates that the coverage rate has exceeded the threshold for coverage rates set in the contracted plan.

### <Effect of Present Embodiment>

According to the present embodiment, it becomes possible to generate a coverage rate information screen containing a printing advice based on the number of elapsed days for which the coverage rate has exceeded the threshold in the case where the current coverage rate has exceeded the threshold for coverage rates designated in the printing service. This makes it possible to generate a printing advice on a basis of the number of elapsed days for which the coverage rate has exceeded the threshold.

The information disclosed in Japanese Patent Laid-Open No. 2023-104559 is to encourage increasing the use amount of the printing material such that the coverage rate becomes large in order to prevent the coverage rate from becoming too small. For this reason, even in the case where the technique of Japanese Patent Laid-Open No. 2023-104559 is employed in generation of information for a user who has exceeded the above-described threshold for coverage rates, it has been impossible to generate information for causing the coverage rate to fall below the threshold for coverage rates.

The present disclosure is to provide a technique for presenting information for appropriately maintaining a use amount of a printing material per a predetermined number of sheets to a user of a subscription service.

### OTHER EMBODIMENTS

The present disclosure is not limited to the above-described embodiments, and various modifications may be made, and parts of the above-described embodiments may be combined as appropriate.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present embodiments, it becomes possible to present information for appropriately maintaining a use amount of a printing material per a predetermined number of sheets to a user of a subscription service.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-114964, filed Jul. 18, 2024, which is hereby incorporated by reference herein in its entirety.

What is claimed is:

1. An information processing apparatus for providing a subscription service of an image forming apparatus to a user, the information processing apparatus comprising:
at least one memory that stores instructions; and
at least one processor that executes the instructions to:
obtain information indicating the number of sheets on which the image forming apparatus performed image formation in a predetermined period and a use amount of a printing material required for the image formation,
derive a use amount of the printing material per a predetermined number of sheets based on the obtained information, and
cause a terminal used by the user to output a UI screen generated based on the derived use amount of the printing material per the predetermined number of sheets and an upper limit of the use amount of the printing material per the predetermined number of sheets in a contract in the subscription service, wherein
the UI screen displays the number of sheets on which image formation can be performed and the use amount of the printing material per the predetermined number of sheets for suppressing the use amount within the upper limit of the use amount of the printing material per the predetermined number of sheets in the contract.

2. The information processing apparatus according to claim 1, wherein
in a case where the derived use amount of the printing material per the predetermined number of sheets is larger than the upper limit of the use amount of the printing material per the predetermined number of sheets in the contract in the subscription service, a remaining grace period is obtained from an elapsed period for excess which has been elapsed since the derived use amount of the printing material per the predetermined number of sheets became larger than the upper limit of the use amount of the printing material per the predetermined number of sheets in the contract in the subscription service, and a predetermined grace period, and
a use amount of the printing material per the predetermined number of sheets on which the image formation can be performed is
a reference use amount of the printing material per the predetermined number of sheets which is associated with a plan of the subscription service, the obtained remaining grace period, a total number of sheets on which the image formation has been performed, and the derived use amount of the printing material per the predetermined number of sheets.

3. The information processing apparatus according to claim 2, wherein
the number of sheets on which the image formation can be performed is obtained from a sum of the derived use amounts of the printing material per the predetermined number of sheets, the reference use amount of the printing material per the predetermined number of sheets, the total number of sheets on which the image formation was performed, and the upper limit of the use amount of the printing material per the predetermined number of sheets in the contract in the subscription service.

4. The information processing apparatus according to claim 1, wherein
in a case where the derived use amount of the printing material per the predetermined number of sheets is smaller than the upper limit of the use amount of the printing material per the predetermined number of sheets in the contract in the subscription service, the use amount of the printing material per the predetermined number of sheets on which the image formation can be performed is a reference use amount of the printing material per the predetermined number of sheets which is associated with a plan of the subscription service, a total number of sheets on which the image formation has been performed, and the derived use amount of the printing material per the predetermined number of sheets.

5. The information processing apparatus according to claim 4, wherein
the number of sheets on which image formation can be performed is obtained from a sum of the derived use amounts of the printing material per the predetermined number of sheets, the reference use amount of the printing material per the predetermined number of sheets, a total number of sheets on which the image formation has been performed, and the upper limit of the use amount of the printing material per the predetermined number of sheets in the contract in the subscription service.

6. The information processing apparatus according to claim 1, wherein
in a case where the derived use amount of the printing material per the predetermined number of sheets is larger than the upper limit of the use amount of the printing material per the predetermined number of sheets in the contract in the subscription service, and an average of latest use amounts of the printing material among the derived use amounts of the printing material per the predetermined number of sheets is not larger than the upper limit of the use amount of the printing material per the predetermined number of sheets in the contract in the subscription service,
the use amount of the printing material per the predetermined number of sheets on which the image formation can be performed is the average of the latest use amounts of the printing material.

7. The information processing apparatus according to claim 6, wherein
the number of copies on which the image formation can be performed is obtained from
a sum of the derived use amounts of the printing material per the predetermined number of sheets, a reference use amount of the printing material per the predetermined number of sheets, the number of sheets on which the image formation was performed in the last time, a total number of sheets on which the image formation has been performed, and the upper limit of the use amount of the printing material per the predetermined number of sheets in the contract in the subscription service.

8. The information processing apparatus according to claim 7, wherein
in the output,
the UI screen containing a remaining grace period obtained from a predetermined grace period and an elapsed period for excess which has been elapsed since the derived use amount of the printing material per the predetermined number of sheets became larger than the upper limit of the use amount of the printing material per the predetermined number of sheets in the contract in the subscription service is outputted.

9. The information processing apparatus according to claim 1, wherein
in a case where the derived use amount of the printing material per the predetermined number of sheets is not larger than the upper limit of the use amount of the printing material per the predetermined number of sheets in the contract in the subscription service, and an average of latest use amounts of the printing material among the derived use amounts of the printing material per the predetermined number of sheets is larger than the upper limit of the use amount of the printing material per the predetermined number of sheets in the contract in the subscription service,
the use amount of the printing material per the predetermined number of sheets on which the image formation can be performed is the average of the latest use amounts of the printing material.

10. The information processing apparatus according to claim 9, wherein
the number of copies on which the image formation can be performed is obtained from
a sum of the derived use amounts of the printing material per the predetermined number of sheets, a reference use amount of the printing material per the predetermined number of sheets, the number of sheets on which the image formation was performed in the last time, a total number of sheets on which the image formation has been performed, and the upper limit of the use amount of the printing material per the predetermined number of sheets in the contract in the subscription service.

11. The information processing apparatus according to claim 1, wherein
in a case where the derived use amount of the printing material per the predetermined number of sheets is larger than the upper limit of the use amount of the printing material per the predetermined number of sheets in the contract in the subscription service,
an elapsed period for excess which has been elapsed since the derived use amount of the printing material per the predetermined number of sheets became larger than the upper limit of the use amount of the printing material per the predetermined number of sheets in the contract in the subscription service is obtained, and
a use amount of the printing material per the predetermined number of sheets on which the image formation can be performed is
a reference use amount of the printing material per the predetermined number of sheets which is associated with a plan of the subscription service and the obtained elapsed period for excess.

12. The information processing apparatus according to claim 11, wherein
the number of sheets on which image formation can be performed is obtained from
a sum of the derived use amounts of the printing material per the predetermined number of sheets, the reference use amount of the printing material per the predetermined number of sheets, the total number of sheets on which the image formation was performed, and the upper limit of the use amount of the printing material per the predetermined number of sheets in the contract in the subscription service.

13. The information processing apparatus according to claim 1, wherein
the UI screen contains an image-formation image in a case where the image formation was performed with the use amount of the printing material per the predetermined number of sheets.

14. The information processing apparatus according to claim 13, wherein
the image-formation image contains an explanatory text for the image-formation image.

15. The information processing apparatus according to claim 13, wherein
the image-formation image contains an explanatory text for the use amount of the printing material per the predetermined number of sheets.

16. The information processing apparatus according to claim 1, wherein
the UI screen contains a region showing a use amount of the printing material per the predetermined number of sheets in a case where the image forming apparatus performed the image formation.

17. The information processing apparatus according to claim 1, wherein
the UI screen contains a region showing an image formation condition for making the use amount equal to or lower than the upper limit of the use amount of the printing material per the predetermined number of sheets in the contract in the subscription service.

18. The information processing apparatus according to claim 1, wherein
the UI screen contains a region showing an advice corresponding to the use amount of the printing material.

19. The information processing apparatus according to claim 1, wherein
the upper limit of the use amount of the printing material per the predetermined number of sheets in the contract in the subscription service is registered in advance.

20. A control method of an information processing apparatus for providing a subscription service of an image forming apparatus to a user, the control method comprising:
obtaining information indicating the number of sheets on which the image forming apparatus performed image formation in a predetermined period and a use amount of a printing material required for the image formation,
deriving a use amount of the printing material per a predetermined number of sheets based on the obtained information, and
causing a terminal used by the user to output a UI screen generated based on the derived use amount of the printing material per the predetermined number of sheets and an upper limit of the use amount of the printing material per the predetermined number of sheets in a contract in the subscription service, wherein
the UI screen displays the number of sheets on which image formation can be performed and the use amount of the printing material per the predetermined number of sheets for suppressing the use amount within the upper limit of the use amount of the printing material per the predetermined number of sheets in the contract.

21. A non-transitory computer readable storage medium storing a program for causing a computer to perform a control method of an information processing apparatus for providing a subscription service of an image forming apparatus to a user, the control method comprising:
obtaining information indicating the number of sheets on which the image forming apparatus performed image formation in a predetermined period and a use amount of a printing material required for the image formation,
deriving a use amount of the printing material per a predetermined number of sheets based on the obtained information, and
causing a terminal used by the user to output a UI screen generated based on the derived use amount of the printing material per the predetermined number of sheets and an upper limit of the use amount of the printing material per the predetermined number of sheets in a contract in the subscription service, wherein
the UI screen displays the number of sheets on which image formation can be performed and the use amount of the printing material per the predetermined number of sheets for suppressing the use amount within the upper limit of the use amount of the printing material per the predetermined number of sheets in the contract.
